(19) United States
(12) Patent Application Publication
(10) Pub. No.: US 2012/0074611 A1
(43) Pub. Date: Mar. 29, 2012

(54) Process of Forming Nano-Composites and Nano-Porous Non-Wovens

(76) Inventors: Hao Zhou, Boiling Springs, SC (US); Walter A. Scrivens, Moore, SC (US)

(21) Appl. No.: 12/893,021

(22) Filed: Sep. 29, 2010

(51) Int. Cl. B29C 51/04

(52) U.S. Cl. 264/164; 977/900

(57) ABSTRACT

A process for forming a nano-composite including mixing a first and second thermoplastic polymer in a molten state forming a molten polymer blend. The second polymer is soluble in a first solvent and the first polymer is insoluble in the first solvent. The first polymer forms discontinuous regions in the second polymer. Next, the polymer blend is subjected to extensional flow, shear stress, and heat forming nanofibers where less than about 30% by volume of the nanofibers are bonded to other nanofibers.

Next the polymer blend with nanofibers is cooled and the first intermediate is formed into a pre-consolidation formation. The pre-consolidation formation is then consolidated causing nanofiber movement, randomization, and at least 70% by volume of the nanofibers to fuse to other nanofibers. According to one aspect, the second intermediate is then subjected to the first solvent to the dissolving away at least a portion of the second polymer.

### RELATED APPLICATIONS

This application is related to the following applications, each of which is incorporated by reference: Attorney docket number 6475 entitled “Core/Shell Nanofiber Non-Woven”, attorney docket number 6483 entitled “Gradient Nanofiber Non-Woven”, attorney docket number 6406 entitled “Nanofiber Non-Wovens Containing Particles”, attorney docket number 6476 entitled “Process of Forming a Nanofiber Non-woven Containing Particles”, attorney docket number 6407 entitled “Multi-Layer Nano-Composites”, and attorney docket number 6477 entitled “Nanofiber Non-Woven Composite”, each of which being filed on Sep. 29, 2010.

### TECHNICAL FIELD

The present application is directed to processes for forming nano-composites and nano-porous non-wovens.

### BACKGROUND

Nanofibers have a high surface area to volume ratio which alters the mechanical, thermal, and catalytic properties of materials. Nanofiber added to composites may either expand or add novel performance attributes to existing applications such as reduction in weight, breathability, moisture wicking, increased absorbency, increased reaction rate, etc. The market applications for nanofibers are rapidly growing and promise to be diverse. Applications include filtration, barrier fabrics, insulation, absorbable pads and wipes, personal care, biomedical and pharmaceutical applications, whiteners (such as TiO2 substitution) or enhanced web opacity, nucleators, reinforcing agents, acoustic substrates, apparel, energy storage, etc. Due to their limited mechanical properties that preclude the use of conventional web handing, loosely interlaced nanofibers are often applied to a supporting substrate such as a non-woven or fabric material. The bonding of the nanofiber cross over points may be able to increase the mechanical strength of the nanofiber non-wovens which potentially help with their mechanical handling and offer superior physical performance.

### BRIEF SUMMARY

The present disclosure provides a process for forming a nano-composite article including mixing a first thermoplastic polymer and a second thermoplastic polymer in a molten state forming a polymer blend. The second polymer is soluble in a first solvent and the first polymer is insoluble in the first solvent. The first polymer forms discontinuous regions in the second polymer. Next, the polymer blend is subjected to extensional flow, shear stress, and heat such that the first polymer forms nanofibers having an aspect ratio of at least 5:1 and wherein less than about 30% by volume of the nanofibers are bonded to other nanofibers. The nanofibers are generally aligned along an axis.

Next the polymer blend with nanofibers is cooled to a temperature below the softening temperature of the first polymer to preserve the nanofiber shape forming a first intermediate. Then the first intermediate is formed into a pre-consolidation formation.

The pre-consolidation formation is then consolidated at a consolidation temperature that is above the T_{g} of both the first polymer and second polymer causing nanofiber movement, randomization, and at least 70% by volume of the nanofibers to fuse to other nanofibers. According to one aspect, the second intermediate is then subjected to the first solvent to the dissolving away at least a portion of the second polymer.

### BRIEF DESCRIPTION OF THE DRAWINGS

FIG. 1 illustrates a process flow diagram for forming a nano-composite.

FIG. 2 illustrates a process flow diagram for forming a nano-porous non-woven.

FIG. 3 illustrates a cross-section of the blend of the first polymer and the second polymer after mixing.

FIG. 4 illustrates a cross-section of the blend of the first polymer and the second polymer after extensional flow.

FIG. 5 illustrates a cross-section of cross-lapped films forming a pre-consolidation formation.

FIG. 6 illustrates a cross-section of a nano-composite.

FIG. 7 illustrates a cross-section of a nano-porous non-woven.

FIG. 8 illustrates a cross-section of a nano-composite with a third component.

FIG. 9 illustrates a cross-section of a nano-porous non-woven with a third component.

FIGS. 10A and 10B are SEMs of the nano-porous non-woven of Example 1.

FIGS. 11A and 11B are SEMs of the nano-porous non-woven of Example 2.

FIGS. 12A and 13B are SEMs of the nano-porous non-woven of Example 3.

FIGS. 13A and 13B are SEMs of the nano-porous non-woven of Example 4.

FIG. 14 is a graph showing DMA versus temperature for Examples 1-5.

FIG. 15 is an SEM of the nano-porous non-woven of Example 6.

FIG. 16 is an SEM of the nano-porous non-woven of Example 7.

FIG. 17 is an SEM of the nano-porous non-woven of Example 8.

FIG. 18 is an SEM of the nano-porous non-woven of Example 9.

FIGS. 19A and 19B are SEMs of the nano-porous non-woven of Example 10.

FIG. 20 is an SEM of the nano-porous non-woven of Example 11.

FIG. 21 is an SEM of the nano-porous non-woven of Example 15.

FIG. 22 is an SEM of the nano-porous non-woven of Example 19 having filtered Staphylococcus bacteria.

FIG. 23 is an SEM of the nano-porous non-woven of Example 20 having filtered red blood cells.

FIG. 24 is an SEM of the nano-porous non-woven of Example 20 having filtered rust particles.

### DETAILED DESCRIPTION

The present invention provides a process for creating a nano-composite having a matrix and nanofibers, where at least 70% of the nanofibers are fused to other nanofibers. The process may further contain a step to remove a portion or substantially all of the matrix material leaving the fused nanofibers as a nano-porous non-woven.

“Nanofiber”, in this application, is defined to be a fiber having a diameter less than 1 micron. In certain instances, the diameter of the nanofiber is less than about 900, 800, 700, 600, 500, 400, 300, 200 or 100 nm, preferably from about 10 nm to about 200 nm. In certain instances, the nanofibers have a diameter from less than 100 nm. The nanofibers may have cross-sections with various regular and irregular shapes including, but not limiting to circular, oval, square, rectangular, triangular, diamond, trapezoidal and polygonal. The number of sides of the polygonal cross-section may vary from 3 to about 16.

“Non-woven” means that the layer or article does not have its fibers arranged in a predetermined fashion such as one set of fibers going over and under fibers of another set in an ordered arrangement.

As used herein, the term “thermoplastic” includes a material that is plastic or deformable, melts to a liquid when heated and freezes to a brittle, glassy state when cooled sufficiently. Thermoplastics are typically high molecular weight polymers. Examples of thermoplastic polymers that may be used include polyacetals, polyacrylics, polycarbonates, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination comprising at least one of the foregoing thermoplastic polymers. In some embodiments, polyolefins include polyethylene, poly(α-olefin)s. As used herein, poly(α-olefin) means a polymer made by polymerizing an alpha-olefin. An α-olefin is an alkene where the carbon-carbon double bond starts at the a-carbon atom. Exemplary poly(α-olefin)s include polypropylene, poly(l-butene) and polystyrene. Exemplary polyesters include condensation polymers of a C₂₋₁₂ dicarboxylic acid and a C₂₋₁₂ alkylenediol. Exemplary polyamides include condensation polymers of a C₂₋₁₂dicarboxylic acid and a C₂₋₁₂ alkylenediamine, as well as polycaprolactam (Nylon 6).

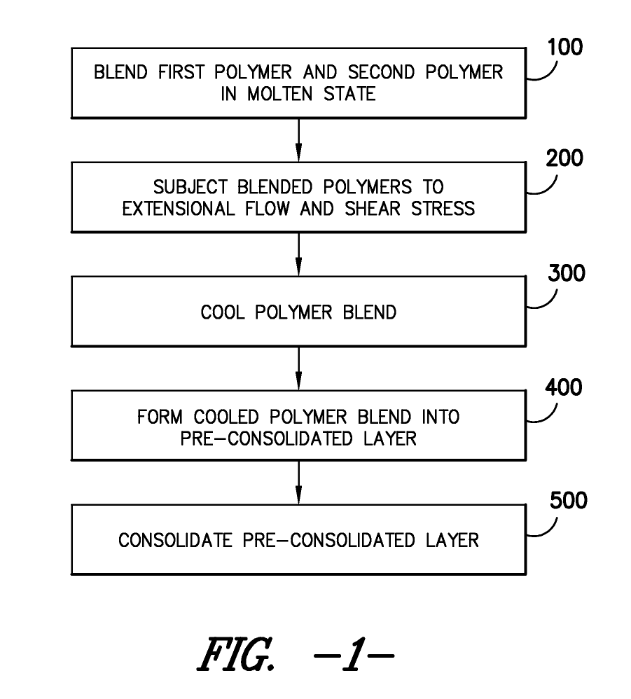

The process shown in FIG. 1 begins with blending a first polymer and a second polymer in a molten state 100. The first polymer forms discontinuous regions in the second polymer. These discontinuous regions may be nano-, micro-, or larger sized liquid drops dispersed in the second polymer. This blend may be cooled and reheated for the subsequent steps or moved directly into the following steps as a melted blend.

The thermoplastic polymer forming the nanofibers is referred herein as the first polymer. The thermoplastic polymer forming the matrix is referred herein as the second polymer. The matrix (second polymer) and the nanofibers (first polymer) may be formed of any suitable thermoplastic polymer that is melt-processable. The second polymer preferably is able to be removed by a condition to which the first polymer is not susceptible. The most common case is the second polymer is soluble in a solvent in which the first polymer is insoluble. “Soluble” is defined as the intermolecular interaction between polymer chain segment and solvent molecules are energetically favorable and caused polymer coils to expand and “insoluble” is defined as polymer-polymer self-interactions are preferred and the polymer coils will contract. Solubility is affected by temperature.

The solvent may be an organic solvent, water, an aqueous solution or a mixture thereof. Preferably, the solvent is an organic solvent. Examples of solvents include, but are not limited to, acetone, alcohol, chlorinated solvents, tetrahydrofuran, toluene, aromatics, dimethylsulfoxide, amides and mixtures thereof. Exemplary alcohol solvents include, but are not limited to, methanol, ethanol, isopropanol and the like. Exemplary chlorinated solvents include, but are not limited to, methylene chloride, chloroform, tetrachloroethylene, carbontetrachloride, dichloroethane and the like. Exemplary amide solvents include, but are not limited to, dimethylformamide, dimethylacetamide, N-methylpyrollidinone and the like. In another embodiment, the second polymer may be removed by another process such as decomposition. For example, polyethylene terephthalate (PET) may be removed with base (such as NaOH) via hydrolysis or transformed into an oligomer by reacting with ethylene glycol or other glycols via glycolysis, or nylon may be removed by treatment with acid. In yet another embodiment, the second polymer may be removed via depolymerization and subsequent evaporation/sublimation of smaller molecular weight materials. For example, polymethyleneoxide, after deprotection, can thermally depolymerize into formaldehyde which subsequently evaporates/sublimes away.

The first and second polymers are thermodynamically immiscible. Common miscibility predictors for non-polar polymers are differences in solubility parameters or Flory-Huggins interaction parameters. For polymers with non-specific interactions, such as polyolefins, the Flory-Huggins interaction parameter may be calculated by multiplying the square of the solubility parameter difference by the factor (V/RT), where V is the molar volume of the amorphous phase of the repeated unit V=M/Δ (molecular weight/density), R is the gas constant, and T is the absolute temperature. As a result, the Flory-Huggins interaction parameter between two non-polar polymers is always a positive number. Thermodynamic considerations require that for complete miscibility of two polymers in the melt, the Flory-Huggins interaction parameter has to be very small (e.g., less than 0.002 to produce a miscible blend starting from 100,000 weight-average molecular weight components at room temperature). It is difficult to find polymer blends with sufficiently low interaction parameters to meet the thermodynamic condition of miscibility over the entire range of compositions. However, industrial experience suggests that some blends with sufficiently low Flory-Huggins interaction parameters, although still not miscible based on thermodynamic considerations, form compatible blends.

Preferably the viscosity and surface energy of the first polymer and the second polymer are close. Theoretically, a 1:1 ratio would be preferred. If the surface energy and/or the viscosity are too dissimilar, nanofibers may not be able to form. In one embodiment, the second polymer has a higher viscosity than the first polymer.

The first polymer and second polymer may be selected from any thermoplastic polymers that meet the conditions stated above, are melt-processable, and are suitable for use in the end product. Suitable polymers for either the first or second polymer include, but are not limited to polyacetals, polyacrylics, polycarbonates, polystyrenes, polyolefins, polyesters, polyamides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polypropylenes, polyethylenes, polyethylene terephthalates, polyvinylidene fluorides, polysiloxanes, or the like, or a combination comprising at least one of the foregoing thermoplastic polymers. In some embodiments, polyolefins include polyethylene, cyclic olefin copolymers (e.g. TOPAS®), poly(α-olefin)s. As used herein, poly(α-olefin) means a polymer made by polymerizing an alpha-olefin. An α-olefin is an alkene where the carbon-carbon double bond starts at the α-carbon atom. Exemplary poly(α-olefin)s include polypropylene, poly(1-butene) and polystyrene. Exemplary polyesters include condensation polymers of a C₂₋₁₂ dicarboxylic acid and a C₂₋₁₂ alkylenediol. Exemplary polyamides include condensation polymers of a C₂₋₁₂ dicarboxylic acid and a C₂₋₁₂ alkylenediamine. Additionally, the first and/or second polymers may be copolymers and blends of polyolefins, styrene copolymers and terpolymers, ionomers, ethyl vinyl acetate, polyvinylbutyrate, polyvinyl chloride, metallocene polyolefins, poly(alpha olefins), ethylene-propylene-diene terpolymers, fluorocarbon elastomers, other fluorine-containing polymers, polyester polymers and copolymers, polyamide polymers and copolymers, polyurethanes, polycarbonates, polyketones, and polyureas, as well as polycaprolactam (Nylon 6).

In one embodiment, some preferred polymers are those that exhibit an alpha transition temperature (Tα) and include, for example: high density polyethylene, linear low density polyethylene, ethylene alpha-olefin copolymers, polypropylene, poly(vinylidene fluoride), poly(vinyl fluoride), poly(ethylene chlorotrifluoroethylene), polyoxymethylene, poly(ethylene oxide), ethyl ene-vinyl alcohol copolymer, and blends thereof. Blends of one or more compatible polymers may also be used in practice of the invention. Particularly preferred polymers are polyolefins such as polypropylene and polyethylene that are readily available at low cost and may provide highly desirable properties in the microfibrous articles used in the present invention, such properties including high modulus and high tensile strength.

Useful polyamide polymers include, but are not limited to, synthetic linear polyamides, e.g., nylon-6, nylon-6,6, nylon-11, or nylon-12. Polyurethane polymers which may be used include aliphatic, cycloaliphatic, aromatic, and polycyclic polyurethanes. Also useful are polyacrylates and polymethacrylates, which include, for example, polymers of acrylic acid, methyl acrylate, ethyl acrylate, acrylamide, methylacrylic acid, methyl methacrylate, n-butyl acrylate, and ethyl acrylate, to name a few. Other useful substantially extrudable hydrocarbon polymers include polyesters, polycarbonates, polyketones, and polyureas. Useful fluorine-containing polymers include crystalline or partially crystalline polymers such as copolymers of tetrafluoroethylene with one or more other monomers such as perfluoro(methyl vinyl)ether, hexafluoropropylene, perfluoro(propyl vinyl)ether; copolymers of tetrafluoroethylene with ethylenically unsaturated hydrocarbon monomers such as ethylene, or propylene.

Representative examples of polyolefins useful in this invention are polyethylene, polypropylene, polybutylene, poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene. Representative blends of polyolefins useful in this invention are blends containing polyethylene and polypropylene, low-density polyethylene and high-density polyethylene, and polyethylene and olefin copolymers containing the copolymerizable monomers, some of which are described above, e.g., ethylene and acrylic acid copolymers; ethyl and methyl acrylate copolymers; ethylene and ethyl acrylate copolymers; ethylene and vinyl acetate copolymers-, ethylene, acrylic acid, and ethyl acrylate copolymers, and ethylene, acrylic acid, and vinyl acetate copolymers.

The thermoplastic polymers may include blends of homo- and copolymers, as well as blends of two or more homo- or copolymers. Miscibility and compatibility of polymers are determined by both thermodynamic and kinetic considerations. A listing of suitable polymers may also be found in PCT published application WO2008/028134, which is incorporated in its entirety by reference.

The thermoplastic polymers may be used in the form of powders, pellets, granules, or any other melt-processible form. The particular thermoplastic polymer selected for use will depend upon the application or desired properties of the finished product. The thermoplastic polymer may be combined with conventional additives such as light stabilizers, fillers, staple fibers, antiblocking agents and pigments. The two polymers are blended while both are in the molten state, meaning that the conditions are such (temperature, pressure) that the temperature is above the melting temperature (or softening temperature) of both of the polymers to ensure good mixing. This is typically done in an extruder. The polymers may be run through the extruder more than once to ensure good mixing to create the discontinuous regions 10 formed from the first polymer in the matrix 20 of the second polymer as shown in FIG. 3.

In one embodiment, the first polymer content of the first polymer/second polymer mixture is about 5% to about 90% by volume, preferably from 10% to about 70% vol, more preferably from 15% to about 60% vol, even more preferably from about 17% to about 50% vol. In another embodiment, the first and second polymers have a volume ratio from about 100:1 to about 1:100, preferably, from about 40:1 to 1:40, more preferably from about 30:1 to about 1:30, even more preferably, from 20:1 to about 1:20; still even more preferably from 10:1 to 1:10; preferably from 3:2 to about 2:3. (4:1, 1:4) Preferably, the second polymer is the major phase comprising more than 50% by volume of the mixture.

Some preferred matrix (second polymer), nanofiber (first polymer), solvent combinations include, but are not limited to:

| Matrix (second polymer) | Nanofiber (first polymer) | Solvent (for matrix) |
|---|---|---|
| Polymethyl methacrylate | Polypropylene (PP) | Toluene |
| (PMMA) | | |
| Cyclic olefin Copolymer | PP | Toluene |
| Cyclic Olefin copolymer | Thermoplastic | Toluene |
| | Elastomer (TPE) | |
| Cyclic Olefin Copolymer | Polyethylene (PE) | Toluene |
| Polystyrene (PS) | Linear Low density | Toluene |
| | polyethylene (LLDPE) | |
| Nylon 6 | PP | Formic Acid |
| Nylon 6 | PE | Formic Acid |
| PS | Polyethylene | Toluene |
| | terephthalate (PET) | |
| PET | PP | decomposition |
| | | through hydrolysis |
| TPU (Thermoplastic | PP | Dimethyl formamide |
| Polyurethane) | | (DMF) |
| TPU | PE | DMF |
| TPU | Nylon | DMF |
| poly(vinyl alcohol) (PVA) | PP | Water |
| Cyclic olefin | TPU | Toluene |
| PS | TPU | Toluene |
| Polycarbonate (PC) | Nylon | Toluene |
| PC | PP | Toluene |
| Polyvinyl chloride (PVC) | PP | Chloroform |
| Noryl (Polyphenyl- | PP | Toluene |
| eneoxide PPO and PS | | |
| blend) | | |
| Noryl | Nylon 6 | Chloroform |
| Polyacrylonitrilebuta- | Nylon 6 | Hexane |
| diene-styrene (ABS) | | |
| ABS | PP | Chloroform |
| PVC | Nylon | Benzene |
| Polybutylenetere- | PE | trifluoroacetic acid |
| phthalate (PBT) | | |

In one embodiment, the second polymer is polystyrene and the first polymer could be linear low density polyethylene (LLDPE), high density polyethylene (HDPE), isotactic polypropylene (iPP), polyethylene terephthalate (PET), polytrimethylene terephthalate (PTT), polybutylene terephthalate (PBT), poly(butylene adipate terephthalate) (PBAT), poly(Ethylene terephthalate-co-isophthalate)-poly(ethylene glycol) (IPET-PEG), and a highly modified cationic ion-dyeable polyester (HCDP).

In one embodiment, the matrix (second polymer) is a water vapor permeable material such as PEBAX resin, a block copolymer of nylon a polyether, by Arkema or a water vapor permeable thermoplastic polyurethane (TPU). The nanofibers in the layer reinforce the layer and also serve as a moisture barrier. When this layer is laminated on a fabric via extrusion coating or calendaring, a breathable water proof fabric composite is created without the matrix material (second polymer) having to be removed.

In one embodiment, any layer of the nano-composite may contain any suitable particle, including nano-particles, micron-sized particles or larger. “Nano-particle” is defined in this application to be any particle with at least one dimension less than one micron. The particles may be, but are not limited to, spherical, cubic, cylindrical, platelet, and irregular. Preferably, the nano-particles used have at least one dimension less than 800 nm, more preferably less than 500 nm, more preferably, less than 200 nm, more preferably less than 100 nm. The particles may be organic or inorganic.

Examples of suitable organic particles include buckminsterfullerenes (fullerenes), dendrimers, organic polymeric nanospheres, aminoacids, and linear or branched or hyperbranched “star” polymers such as 4, 6, or 8 armed polyethylene oxide with a variety of end groups, polystyrene, superabsorbing polymers, silicones, crosslinked rubbers, phenolics, melamine formaldehyde, urea formaldehyde, chitosan or other biomolecules, and organic pigments (including metallized dyes).

Examples of suitable inorganic particles include, but are not limited to, calcium carbonate, calcium phosphate (e.g., hydroxy-apatite), talc, mica, clays, metal oxides, metal hydroxides, metal sulfates, metal phosphates, silica, zirconia, titania, ceria, alumina, iron oxide, vanadia, antimony oxide, tin oxide, alumina/silica, zirconium oxide, gold, silver, cadmium selenium, chalcogenides, zeolites, nanotubes, quantum dots, salts such as CaCO₃, magnetic particles, metal-organic frameworks, and any combinations thereof.

In one embodiment, the particles are further functionalized. Via further chemistry, the third surface of the particles may have added functionality (reactivity, catalytically functional, electrical or thermal conductivity, chemical selectivity, light absorbtion) or modified surface energy for certain applications.

In another embodiment, particles are organic-inorganic, coated, uncoated, or core-shell structure. In one embodiment, the particles are PEG (polyethylene glycol) coated silica, PEG coated iron oxide, PEG coated gold, PEG coated quantum dots, hyperbranched polymer coated nano-clays, or other polymer coated inorganic particles such as pigments. The particles, in one embodiment, may melt and re-cool in the process of forming the nanofiber non-woven. The particles may also be an inorganic core-inorganic shell, such as Au coated magnetic particles. The particles, in one embodiment, may melt and re-cool in the process of forming the nanofiber non-woven. In another embodiment, the particles are ZELEC®, made by Milliken and Co. which has a shell of antimony tin oxide over a core that may be hollow or solid, mica, silica or titania. A wax or other extractible coating (such as functionalized copolymers) may cover the particles to aid in their dispersion in the matrix polymer.

In another embodiment, a third polymer may be added. This third polymer is a thermoplastic that may be form additional nanofibers or additional matrix. The third polymer may be soluble or insoluble in the solvent that the second polymer is soluble in, depending on the desired end product. In one embodiment, the first and third polymers are insoluble in a solvent that the second polymer is soluble in. The amounts of polymers are selected such that the first and third polymers form nanofibers in a matrix of the second polymer. This second polymer may be partially or fully removed by the solvent. In another embodiment, the first polymer is insoluble in a solvent that the second polymer and the third polymer are soluble in. The amounts of polymers are selected such that the first polymer forms nanofibers in a matrix of the second polymer and the third polymer. The second and third polymers may be partially or fully removed by the solvent. In another embodiment, the second polymer is soluble in a first solvent, the third polymer is soluble in a second solvent, and the first polymer is insoluble in the first and second solvents. The amounts of polymers are selected such that the first polymer forms nanofibers in a matrix of the second polymer and the third polymer. This second and third polymer may be selectively removed by the first and/or second solvent.

In another embodiment, a third component, reactive or non-reactive, such as a compatiblizer, a blooming agent, or a co-polymer may be add in the system so at least part of it migrates to the interface between the first and second polymer in the first intermediate. Such a third component may be selected to be partially soluble or insoluble in the second solvent. This third component will be exposed on the surface of the first polymer after etching. Via further chemistry, the third component surface of the first polymer may have added functionality (reactivity, catalytically functional, conductivity, chemical selectivity) or modified surface energy for certain applications. For example, in a PS/PP system (second polymer/first polymer), PP-g-MAH (maleated PP) or PP-g-PS, styrene/ethylene-butylene/styrene (SEBS) may be added to the system. The added MAH and the styrene functional groups may be further reacted to add functionality to the nano-composite or nano-porous non-woven.

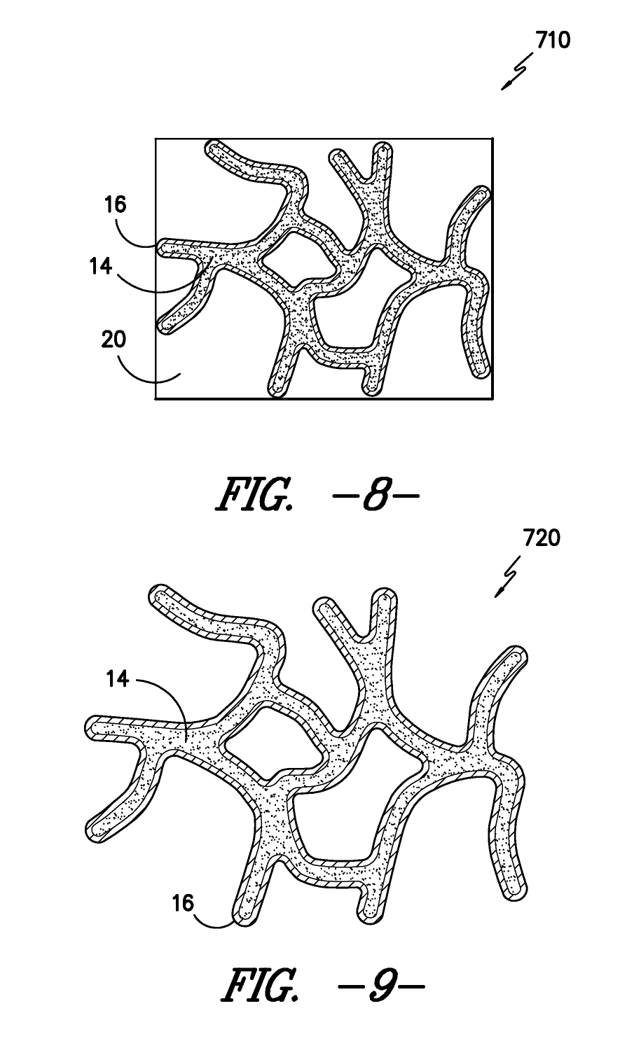

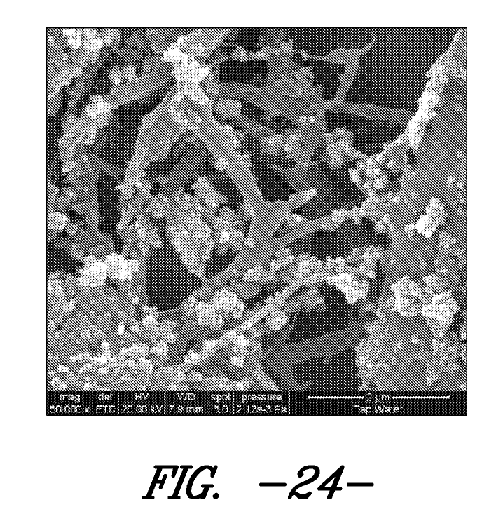

FIG. 8 illustrates a cross-section of a nano-composite having a third polymer 16 at the interface between the matrix 20 and the nanofibers 14. FIG. 9 illustrates a cross-section of a nano-porous non-woven having the third polymer 16 surrounding the nanofibers 14. The third polymer 16 may partially, almost completely, or completely encapsulate the nanofibers 14. In one embodiment, the third polymer 16 is between the bonding sites of the nanofibers, and in another embodiment (shown in FIG. 23), the third polymer is not present between the nanofibers where they are bonded to other nanofibers. The third polymer may also be, in one embodiment, the same polymer as the nanofibers, but at a different molecular weight. This would affect the solubility of the nanofibers during extraction of the matrix material (second polymer).

In one embodiment, the nanofibers are core/shell nanofibers. The cores and shells may have any suitable thickness ratio depending on the end product. The core (formed from the first polymer) of the nanofiber extends the length of the nanofiber and forms the center of the nanofiber. The shell of the fiber at least partially surrounds the core of the nanofiber, more preferably surrounds approximately the entire outer surface of the core. Preferably, the shell covers both the length of the core as well as the smaller ends of the core. The shell polymer may be any suitable polymer, preferably selected from the listing of polymers for the first polymer and the second polymer.

At least a portion of the core polymer interpenetrates the shell of the nanofiber and at least a portion of the shell polymer interpenetrates the core of the nanofiber. This occurs as the core and shell polymers are heated and formed together. The polymer chains from the core polymers interpenetrate the shell and the polymer chains from the shell polymer interpenetrate the core and the core and shell polymers intermingle. This would not typically occur from a simple coating of already formed nanofibers with a coating polymer.

In one embodiment, the matrix polymer is polystyrene and the core polymer could be linear low density polyethylene (LLDPE), high density polyethylene (HDPE), isotactic polypropylene (iPP), polyethylene terephthalate (PET), polytrimethylene terephthalate (PTT), polybutylene terephthalate (PBT), poly(butylene adipate terephthalate) (PBAT), poly(Ethylene terephthalate-co-isophthalate)-poly(ethylene glycol) (IPET-PEG), and a highly modified cationic ion-dyeable polyester (HCDP).

The core and shell polymers may be chosen with to have a different index of refraction or birefringence for desired optical properties. In another embodiment, the core polymer is soluble in a second solvent (which may be the same solvent or different solvent as the first solvent), such that the core of the core/shell nanofibers may be removed leaving bonded hollow nanofibers.

In another embodiment, the nano-composite contains at least one textile layer which may be any suitable textile layer. The textile layer may be on one or both sides of the nano-composite, or between some layers of the nano-composite. If more than one textile layer is used, they may each contain the same or different materials and constructions. In one embodiment, the textile layer is selected from the group consisting of a knit, woven, non-woven, and unidirectional layer. The textile layer provides turbulence of the molten mixture of the first and second polymer during extrusion and/or subsequent consolidation causing nanofiber movement, randomization, and bonding. The textile layer may be formed from any suitable fibers and/or yarns including natural and man-made. Woven textiles can include, but are not limited to, satin, twill, basket-weave, poplin, and crepe weave textiles. Jacquard woven textiles may be useful for creating more complex electrical patterns. Knit textiles can include, but are not limited to, circular knit, reverse plaited circular knit, double knit, single jersey knit, two-end fleece knit, three-end fleece knit, terry knit or double loop knit, warp knit, and warp knit with or without a micro denier face. The textile may be flat or may exhibit a pile. The textile layer may have any suitable coating upon one or both sides, just on the surfaces or through the bulk of the textile. The coating may impart, for example, soil release, soil repel/release, hydrophobicity, and hydrophilicity.

As used herein yarn shall mean a continuous strand of textile fibers, spun or twisted textile fibers, textile filaments, or material in a form suitable for knitting, weaving, or otherwise intertwining to form a textile. The term yarn includes, but is not limited to, yarns of monofilament fiber, multifilament fiber, staple fibers, or a combination thereof. The textile material may be any natural or man-made fibers including but not limited to man-made fibers such as polyethylene, polypropylene, polyesters (polyethylene terephthalate, polybutylene terephthalate, polytrimethylene terephthalate, polylactic acid, and the like, including copolymers thereof), nylons (including nylon 6 and nylon 6,6), regenerated cellulosics (such as rayon), elastomeric materials such as Lycra™, high-performance fibers such as the polyaramids, polyimides, PEI, PBO, PBI, PEEK, liquid-crystalline, thermosetting polymers such as melamine-formaldehyde (BASOFIL™) or phenol-formaldehyde (KYNOL™), basalt, glass, ceramic, cotton, coir, bast fibers, proteinaceous materials such as silk, wool, other animal hairs such as angora, alpaca, or vicuna, and blends thereof.

In another embodiment, the nano-composite further comprises a support layer which may be one at least one side of the nano-composite. The nano-composite and supporting layer may formed together, preferably through co-extrusion or attached together at a later processing step. If the supporting layer is co-extruded, then the supporting layer contains the supporting polymer which may be any suitable thermoplastic that is co-extrudable which the choice of first polymer and second polymer. The supporting polymer may be selected from the listing of possible thermoplastic polymers listed for the first polymer and the second polymer. In one embodiment, the supporting polymer is the same polymer as the second polymer or is soluble in the same solvent as the second polymer. This allows the matrix (second polymer) and the supporting layer (which is a sacrificial layer) to be removed at the same time leaving just the nanofibers in the nanofiber non-woven layer. In another embodiment, the supporting polymer is a different polymer than the second polymer and is not soluble in the same solvents as the second polymer. This produces a nano-composite on the supporting layer after removing the second polymer which is advantageous for applications that require a non-woven having increased dimensional stability and strength. The supporting layer decreases the edge effects of extruding or otherwise forming the nanofiber non-woven layer so that the size and density of the nanofibers is more even across the thickness (from the first side to the second side) of the nano-composite.

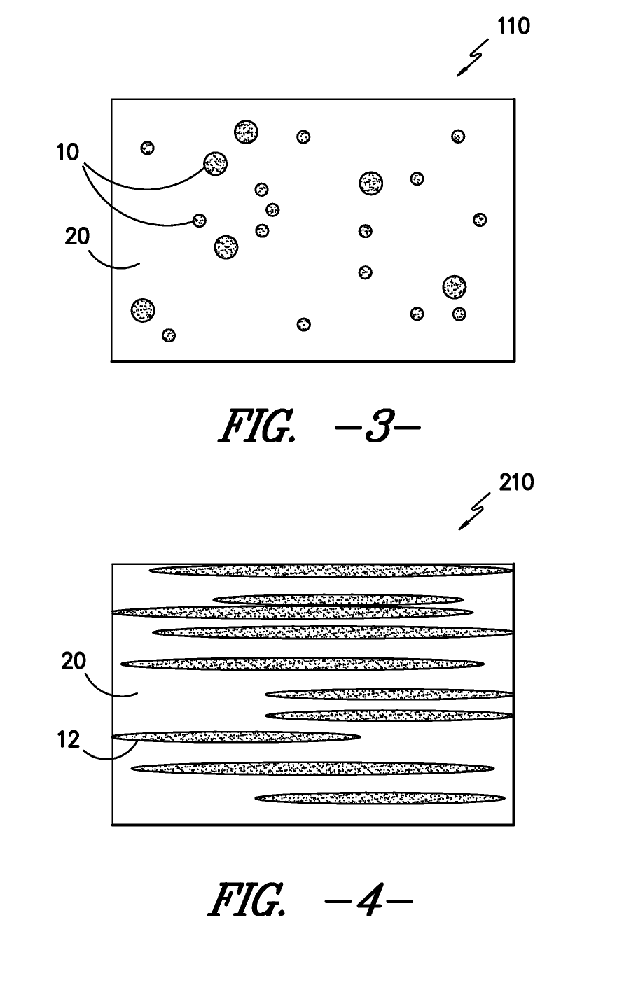

Referring back to FIG. 1, the next step (step 200), the molten polymer blend is subjected to extensional flow and shear stress such that the first polymer forms nanofibers. The nanofibers formed have an aspect ratio of at least 5:1 (length to diameter), more preferably, at least 10:1, at least 50:1, at least 100:1, and at least 1000:1. The nanofibers are generally aligned along an axis, referred to herein as the “nanofiber axis”. Preferably, at least 80% of the nanofibers are aligned within 20 degrees of this axis. After the extensional flow less than 30% by volume of the nanofibers are bonded to other nanofibers. This means that at least 70% of the nanofibers are not bond (adhered or otherwise) to any other nanofiber. Should the matrix (second polymer) by removed at this point, the result would be mostly separate individual nanofibers. In another embodiment, after step 200, less than 20%, less than 10%, or less than 5% of the nanofibers are bonded to other nanofibers. FIG. 4 illustrates a cross-section of the polymer blend after the extensional forces of step 200. As may be seen, most of the fibers are aligned in a single direction and are not bonded to other nanofibers.

In one embodiment, the mixing of the first and second polymers (step 100) and the extension flow (step 200) may be performed by the same extruder, mixing in the barrel of the extruder, then extruded through the die or orifice. The extensional flow and shear stress may be from, for example, extrusion through a slit die, a blown film extruder, a round die, injection molder, or a fiber extruder.

In step 300, the molten polymer blend is cooled to a temperature below the softening temperature of the first polymer to preserve the nanofiber shape. “Softening temperature” is defined to be the temperature where the polymers start to flow. For crystalline polymers, the softening temperature is the melting temperature. For amorphous polymers, the softening temperature is the Vicat temperature. This cooled molten polymer blend forms the first intermediate.

Next, the first intermediate is formed into a pre-consolidation formation in step 400. Forming the first intermediate into a pre-consolidation formation involves arranging the first intermediate into a form ready for consolidation. The pre-consolidation formation may be, but is not limited to, a single film, a stack of multiple films, a fabric layer (woven, non-woven, knit, unidirectional), a stack of fabric layers, a layer of powder, a layer of polymer pellets, an injection molded article, or a mixture of any of the previously mentioned. The polymers in the pre-consolidation formation may be the same through the layers and materials or vary.

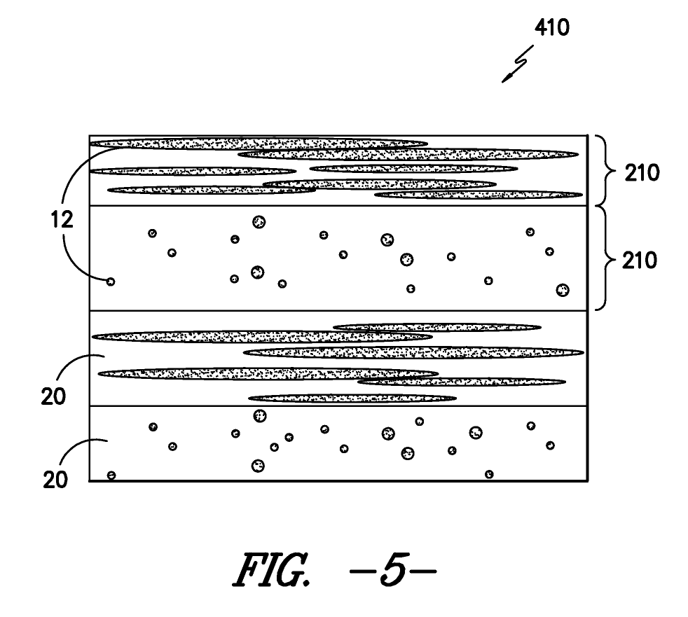

In a first embodiment, the pre-consolidation formation is in the form of a fabric layer. In this embodiment, the molten polymer blend is extruded into fibers which form the first intermediate. The fibers of the first intermediate are formed into a woven, non-woven, knit, or unidirectional layer. This fabric layer may be stacked with other first intermediate layers such as additional fabric layers or other films or powders. In a second embodiment, the pre-consolidation formation is in the form of a film layer. In this embodiment, the molten polymer blend is extruded into a film which forms the first intermediate. The film may be stacked with other films or other first intermediate layers. The film may be consolidated separately or layered with other films. In one embodiment, the films are stacked such that the nanofiber axes all align. In another embodiment, shown in FIG. 5, the films 210 are cross-lapped such that the nanofiber axis of one film is perpendicular to the nanofiber axes of the adjacent films forming the pre-consolidation formation 410. If two or more films are used, they may each contain the same or different polymers. For example, a PP/PS 80%/20% wt film may be stacked with a PP/PS 75%/25% wt film. Additionally, a PE/PS film may be stacked on a PP/PS film. Other angles for cross-lapping may also be employed.

In a third embodiment, the pre-consolidation formation is in the form of a structure of pellets, which may be a flat layer of pellets or a three-dimensional structure. In this embodiment, the molten polymer blend is extruded into a fiber, film, tube, elongated cylinder or any other shape and then is pelletized which forms the first intermediate. Pelletizing means that the larger cooled polymer blend is chopped into finer components. The most common pelletizing method is to extrude a pencil diameter fiber, then chop the cooled fiber into pea-sized pellets. The pellets may be covered or layered with any other first intermediate structures such as fabric layers or film layers.

In a fourth embodiment, the pre-consolidation formation is in the form of a structure of a powder, which may shaped into be a flat layer of powder or a three-dimensional structure. In this embodiment, the molten polymer blend is extruded, cooled, and then ground into a powder which forms the first intermediate. The powder may be covered or layered with any other first intermediate structures such as fabric layers or film layers.

In a fifth embodiment, the pre-consolidation formation is in the form of a structure of an injection molded article. The injection molded first intermediate may be covered or layered with any other first intermediate structures such as fabric layers or film layers.

Additionally, the pre-consolidation formation may be layered with other layers (not additional first intermediates) such as fabric layers or other films not having nanofibers or embedded into additional layers or matrixes. One such example would be to embed first intermediate pellets into an additional polymer matrix. The pre-consolidation layer may also be oriented by stretching in at least one axis.

In the next step, step 500, consolidation is conducted at a temperature is above the T_{g} and of both the first polymer and second polymer and within 50 degrees Celsius of the softening temperature of first polymer. More preferably, consolidation is conducted at 20 degrees Celsius of the softening temperature of the first polymer. The consolidation temperature upper limit is affected by the pressure of consolidation and the residence time of consolidation. For example, a higher consolidation temperature may be used if the pressure used is high and the residence time is short. If the consolidation is conducted at a too high a temperature, too high a pressure and/or too long a residence time, the fibers might melt into larger structures or revert back into discontinuous or continuous spheres.

Consolidating the pre-consolidation formation causes nanofiber movement, randomization, and at least 70% by volume of the nanofibers to fuse to other nanofibers. This forms the second intermediate. This movement, randomization, and bonding of the nanofibers may be accomplished two ways. On being that the pre-consolidation formation contains multiple nanofiber axes. This may arise, for example, from stacking cross-lapped first intermediate layers or using a non-woven, or powder. When heat and pressure is applied during consolidation, the nanofibers move relative to one another and bond where they interact. Another method of randomizing and forming the bonds between the nanofibers is to use a consolidation surface that is not flat and uniform. For example, if a textured surface or fabric were used, even if the pressure was applied uniformly, the flow of the matrix and the nanofibers would be turbulent around the texture of the fabric yarns or the textured surface causing randomization and contact between the nanofibers. If one were to simply consolidate a single layer of film (having most of the nanofibers aligned along a single nanofiber axis) using a press that delivered pressure perpendicular to the plane of the film, the nanofibers would not substantially randomize or bond and once the matrix was removed, predominately individual (unattached) nanofibers would remain.

In pre-consolidation formations such as powders or pellets the nanofiber axes are randomized and therefore a straight lamination or press would produce off-axis pressure. If the first intermediate of FIG. 4 were used as the pre-consolidation formation and was pressured using a carver press (pressure would be perpendicular to the nanofiber axis, 70% of the nanofibers would not bond to one another. The pre-consolidation formation of FIG. 5, when consolidated, would bond at least 70% of the nanofibers to one another. The temperature, pressure, and time of consolidation would move the nanofibers between the first intermediate layers 210 causing randomization and bonding of the nanofibers. Preferably, at least 75% vol of the nanofibers to bond to other nanofibers, more preferably at least 85% vol, more preferably at least 90% vol, more preferably at least 95% vol, more preferably at least 98% vol. Consolidation forms the second intermediate, also referred to as the nano-composite.

At applied pressure and temperature, the second polymer is allowed to flow and compress resulting in bringing “off-axis” nanofibers to meet at the cross over points and fuse together. Additional mixing flow of the second polymer may also be used to enhance the mixing and randomization of the off-axis fibers. One conceivable means is using a textured non-melting substrate such as a fabric (e.g. a non-woven), textured film, or textured calendar roll in consolidation. Upon the application of pressure, the local topology of the textured surface caused the second polymer melt to undergo irregular fluctuations or mixing which causes the direction of the major axis of the nanofibers to alter in plane, resulting in off-axis consolidations. In a straight lamination or press process, due to the high melt viscosity and flow velocity, the flow of the second polymer melt is not a turbulent flow and cross planar flow is unlikely to happen. When the majority of the nanofibers are in parallel in the same plane, the nanofibers will still be isolated from each other, resulting in disintegration upon etching.

The second intermediate 510 (also called nano-composite 510) contains the nanofibers 14 formed from the first polymer, where at least 70% vol of the nanofibers are bonded to other nanofibers in a matrix 20 of the second polymer and is shown in FIG. 6. This intermediate 510 may be used, for example, in reinforcement structures, or a portion or the entire second polymer may be removed.

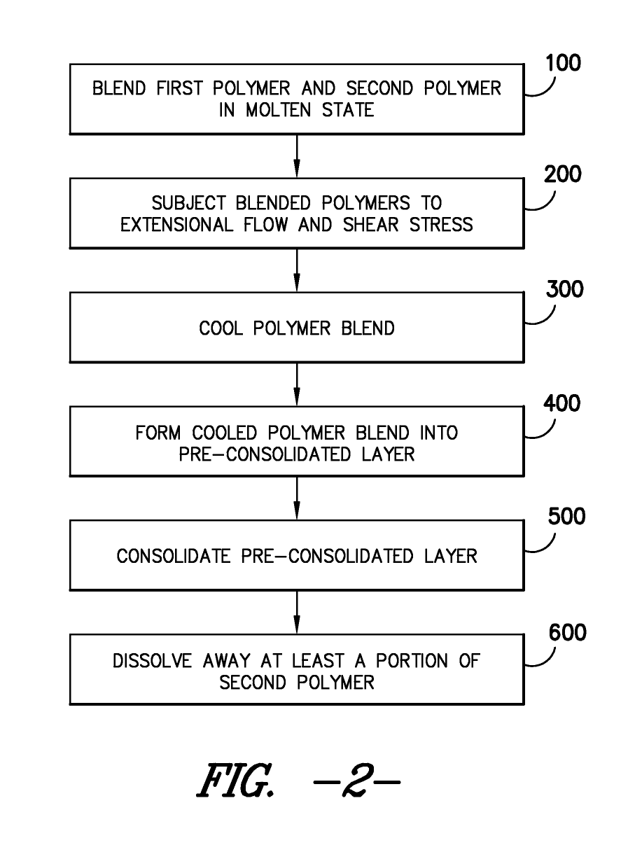

FIG. 2 illustrates an additional step 600 of dissolving at least a portion of the second polymer from the nano-composite. A small percentage (less than 30% vol) may be removed, most, or all of the second polymer may be removed. If just a portion of the second polymer is removed, it may be removed from the outer surface of the intermediate leaving the nano-composite having a nanofiber non-woven surrounding the center of the article which would remain a nano-composite. The removal may be across one or more surfaces of the second intermediate 510 or may be done pattern-wise on the second intermediate 510. Additionally, the second polymer 20 may be removed such that there is a concentration gradient of the second polymer in the final product with the concentration of the second polymer the lowest at the surfaces of the final product and the highest in the center. The concentration gradient may also be one sided, with a concentration of the second polymer higher at one side.

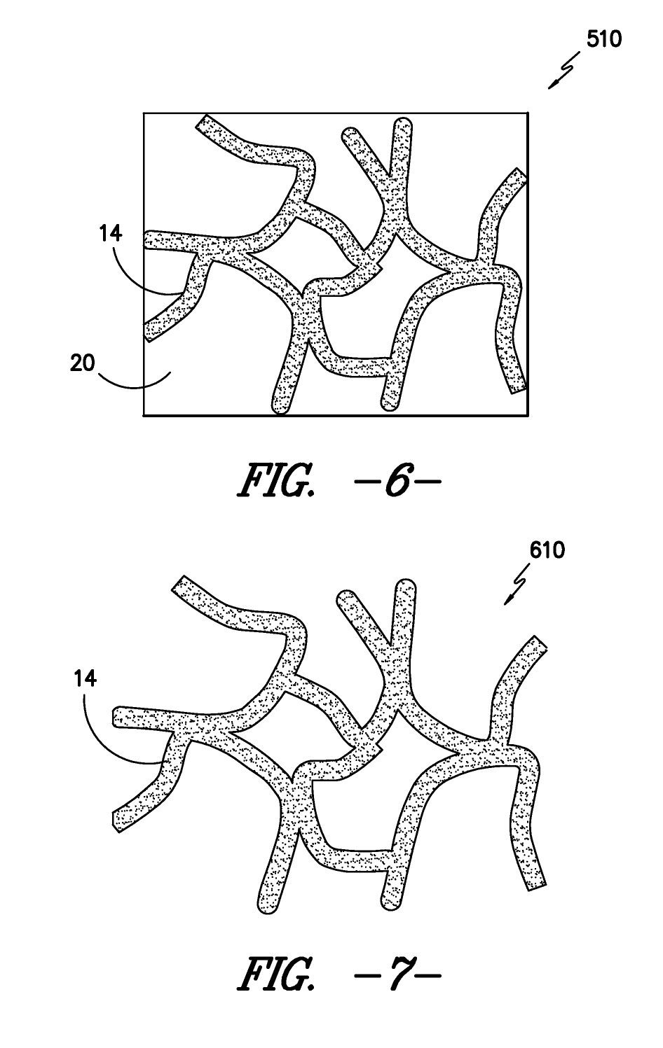

If essentially the entire or the entire second polymer is removed from the second intermediate, what remains is a nano-porous non-woven 610 shown in FIG. 7, where at least 70% vol of the nanofibers are bonded to other nanofibers. While the resultant structure is described as a nano-porous non-woven, the resultant structure may consist of a non-woven formed from bonded nanofibers and resemble a non-woven more than a film. The bonding between the nanofibers 14 provides physical integrity for handling of the etched films/non-woven in the etching process which makes the use of a supporting layer optional. Smearing and/or tearing of the nanofibers upon touching is commonly seen in the poorly consolidated second intermediates 510. The second polymer may be removed using a suitable solvent or decomposition method described above.

The benefit of the process of consolidating the pre-consolidation layer is the ability to form the bonds between the nanofibers without losing the nanofiber structure. If one were to try to bond the nanofibers in a nanofiber non-woven, when heat is applied, the nanofibers would all melt together and the nanofibers would be lost. This would occur when the heat is uniform, such as a lamination or nip roller, or is specific such as spot welding or ultrasonics.

In one embodiment, the nano-composite 510 and/or the nano-porous non-woven 610 may contain additional microfibers and/or engineering fibers. Engineering fibers are characterized by their high tensile modulus and/or tensile strength. Engineering fibers include, but are not limited to, E-glass, S-glass, boron, ceramic, carbon, graphite, aramid, poly(benzoxazole), ultra high molecular weight polyethylene (UHMWPE), and liquid crystalline thermotropic fibers. The use of these additional fibers in the composites and non-wovens/films may impart properties that maynot be realized with a single fiber type. For example, the high stiffness imparted by an engineering fiber may be combined with the low density and toughness imparted by the nanofibers. The extremely large amount of interfacial area of the nanofibers may be effectively utilized as a means to absorb and dissipate energy, such as that arising from impact. In one embodiment a nanofibers mat comprised of hydrophobic nanofibers is placed at each of the outermost major surfaces of a mat structure, thereby forming a moisture barrier for the inner layers. This is especially advantageous when the inner layers are comprised of relatively hydrophilic fibers such as glass.

In one embodiment, the bonded nanofibers may improve the properties of existing polymer composites and films by providing nanofiber-reinforced polymer composites and films, and corresponding fabrication process, that have a reduced coefficient of thermal expansion, increased elastic modulus, improved dimensional stability, and reduced variability of properties due to either process variations or thermal history. Additionally, the increased stiffness of the material due to the nanofibers may be able to meet given stiffness or strength requirements.

The bonded nanofibers of the nano-porous non-woven 610 may be used in many known applications employing nanofibers including, but not limited to, filter applications, computer hard drive applications, biosensor applications and pharmaceutical applications. The nanofibers are useful in a variety of biological applications, including cell culture, tissue culture, and tissue engineering applications. In one application, a nanofibrillar structure for cell culture and tissue engineering may be fabricated using the nanofibers of the present invention.

### EXAMPLES

Various embodiments are shown by way of the Examples below, but the scope of the invention is not limited by the specific Examples provided herein.

### Example 1

The first polymer was Homopolymer Polypropylene (HPP), obtained in granule form from Lyondell Basell as Pro-fax 6301 and had a melt flow of 12 g/10 min (230° C., ASTMD 1238). The granule HPP was pelletized using a twin screw extruder Prism TSE 16TC. The second polymer was Cyrtal Polystyrene (PS), obtained in pellet form from Total Petrochemicals as PS 500 and had a melt flow of 14 g/10 min (200° C., ASTMD 1238). The PS and HPP pellets were premixed in a mixer at a weight ratio of 80/20. The mixture was fed into a co-rotating 16 mm twin-screw extruder, Prism TSE 16TC. The feed rate was 150 g min⁻¹ and the screw speed was 92 rpm. Barrel temperature profiles were 225, 255, 245, 240, and 235° C. The blend was extruded through a rod die where the extrudate was subject to an extensional force that was sufficient to generate nanofibrillar structure. The extrudate was cooled in a water bath at the die exit and collected after passing through a pelletizer. The pellets were the first intermediate and contained parallel HPP nanofibers (approximately 80% of the fibers had a diameter less than 500 nm and have an aspect ratio of greater than 40:1). When a section of the first intermediate was etched, the sample had no structural integrity indicating that a small percentage of the nanofibers were bonded to other nanofibers.

The first intermediate pellets were randomly arranged into a layer to form the pre-consolidation formation. The pre-consolidation formation was compression molded for 15 min using a carver hydraulic press forming the second intermediate, a solid nano-composite film with a thickness of 0.3 mm. The compression temperature was 320° F. and the compression pressure was 30 tons. This consolidation temperature was approximately the melting point of the PS. It was determined that approximately 90% of the HPP fibers were bonded to other HPP nanofibers.

The second intermediate was immersed in toluene at room temperature for 30 minutes to remove PS from the blends as PS is soluble in toluene and PP is insoluble in toluene. This step was repeated for two more times to ensure complete removal of polystyrene. The etched film was then immersed in acetone and methanol for 30 minutes respectively, then air dried. The weight of the etched film was 20% of the original blend indicating that all or approximately all of the PS was removed.

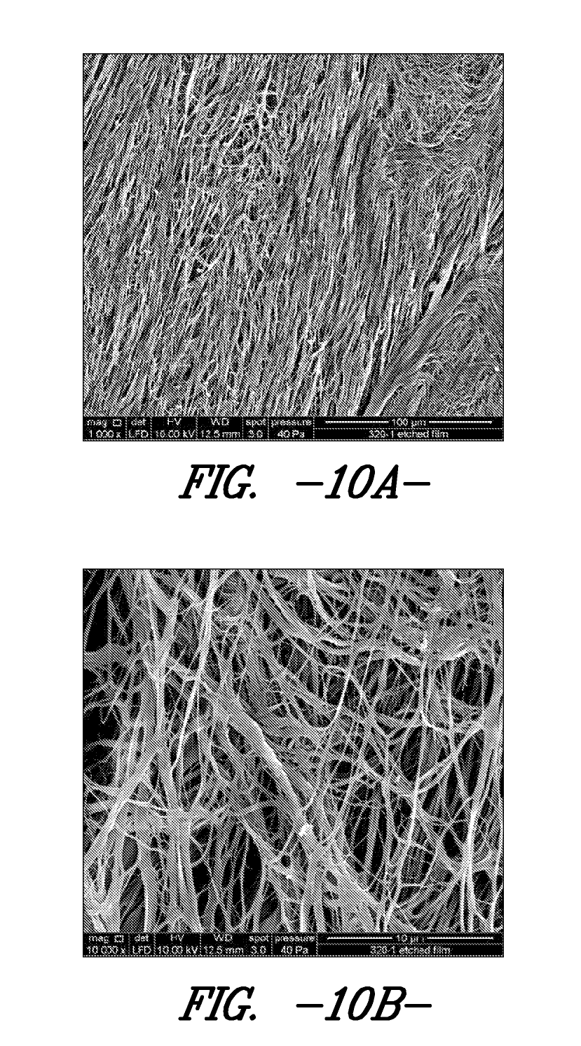

The morphology of the etched nano-composite article was observed using a smayning electron microscope (SEM). The SEM images (FIG. 10A, 1000×, FIG. 10B, 10000×) represent the top view of the etched films. The nanofibers are randomly connected and fused together, see FIGS. 10A and 10B.

### Example 2

Example 2 was carried out with the same materials and process of Example 1, except that the consolidation temperature was 340° F. This consolidation temperature was 20° F. higher the melting point of HPP.

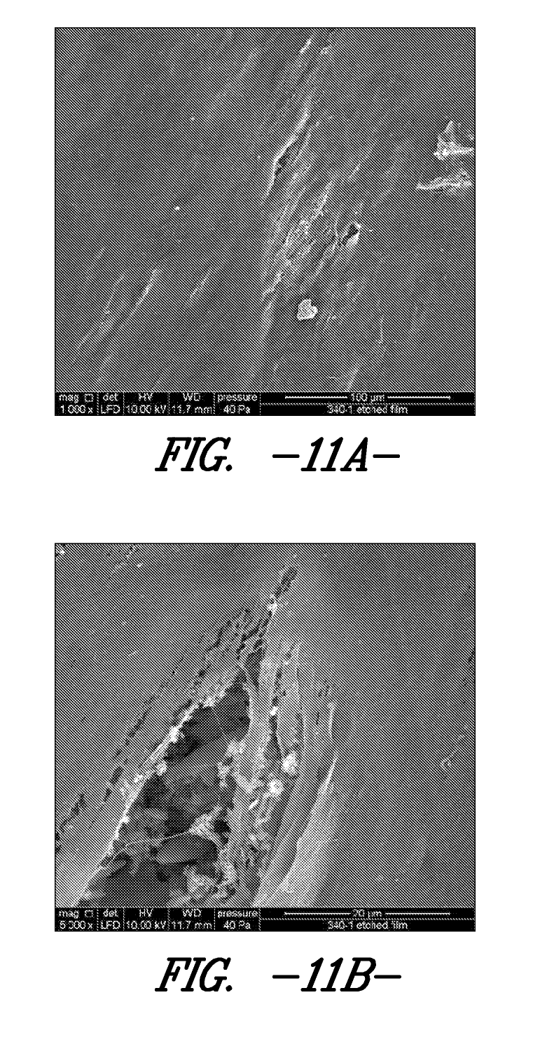

The morphology of the etched nano-composite article was observed using a SEM (FIG. 11A—1000× and FIG. 11B—10000×) represent the top view of the etched films. The nanofibers melted and fused into sheet like structure during consolidation and the nanofibers were destroyed. This consolidation temperature (at the given pressure and long resonance time) was proven to be too high to produce a nano-porous structure.

### Example 3

Example 3 was carried out with the same materials and process of Example 1, except that the consolidation temperature was 280° F. This consolidation temperature was 40° F. lower the melting point of HPP.

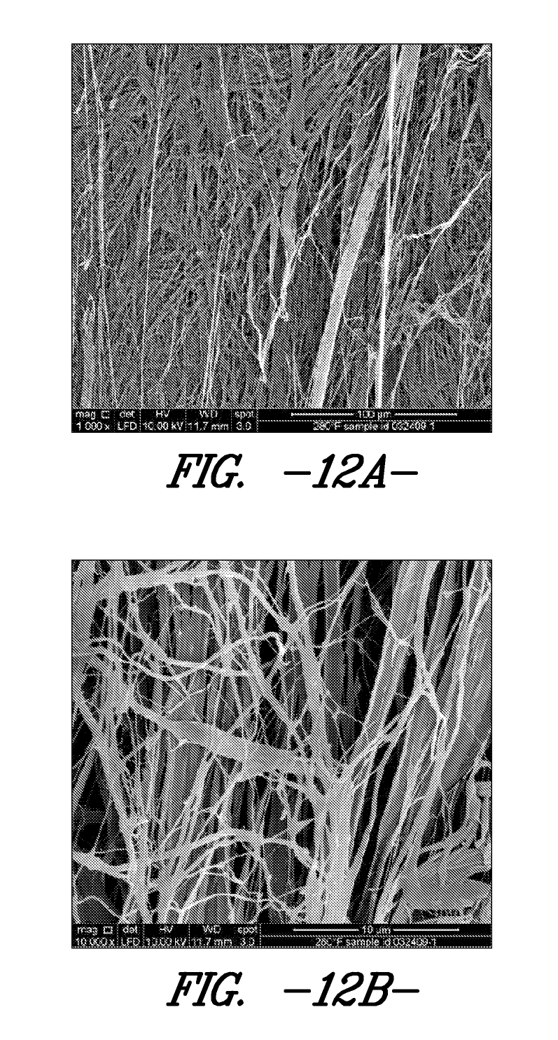

The morphology of the etched nano-composite article was observed using a SEM (FIG. 12A—1000×, FIG. 12B—10000×) represent the top view of the etched films. The nanofibers in the film were loosely connected and the film was very fragile to handle during testing indicating that less than 70% of the nanofibers were bonded to other nanofibers. This combination of consolidation temperature, pressure and resonance time was proven to be too low to produce nano-porous non-woven with good physical strength.

### Example 4

Example 4 was carried out with the same materials and process of Example 1, except that the consolidation temperature was 300° F. This consolidation temperature was 20° F. lower the melting point of HPP.

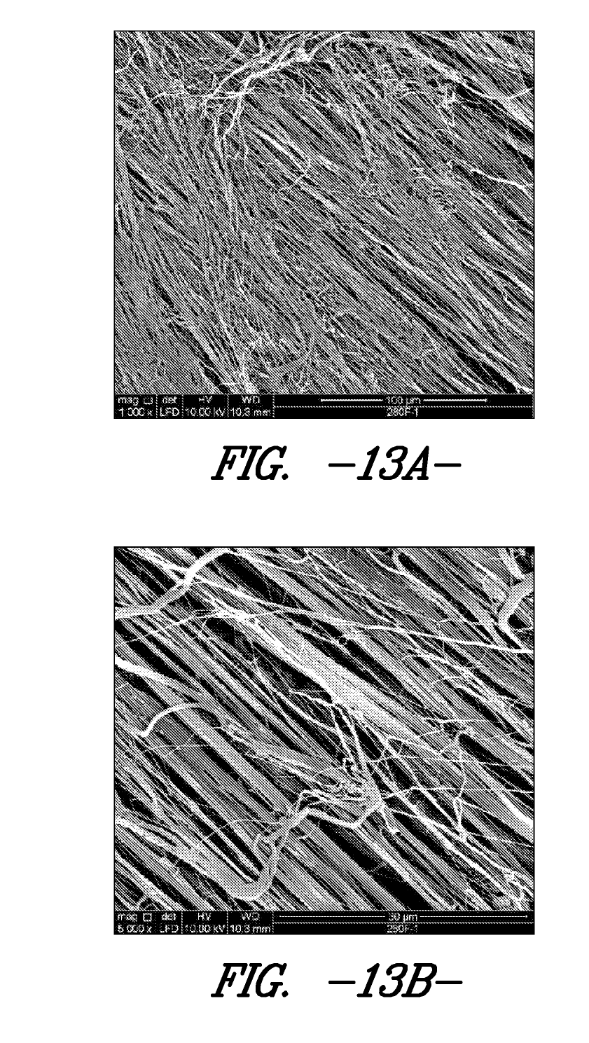

The morphology of the etched nano-composite article was observed using an SEM (FIG. 13A—1000×, FIG. 13B—5000×) represent the top view of the etched films. It may be seen that HPP nanofibers had started softening and bonding together at this temperature, but at least 70% of the nanofibers were not bonded together resulting in a structure that lacked integrity.

### Example 5

Example 5 was carried out with the same materials and process of Example 1, except that the consolidation temperature was 360° F. This consolidation temperature was 40° F. higher than the melting point of HPP. The second intermediate disintegrated during etching. The nanofibers had ripened reverting back to discontinuous more circular regions from the nanofibers.

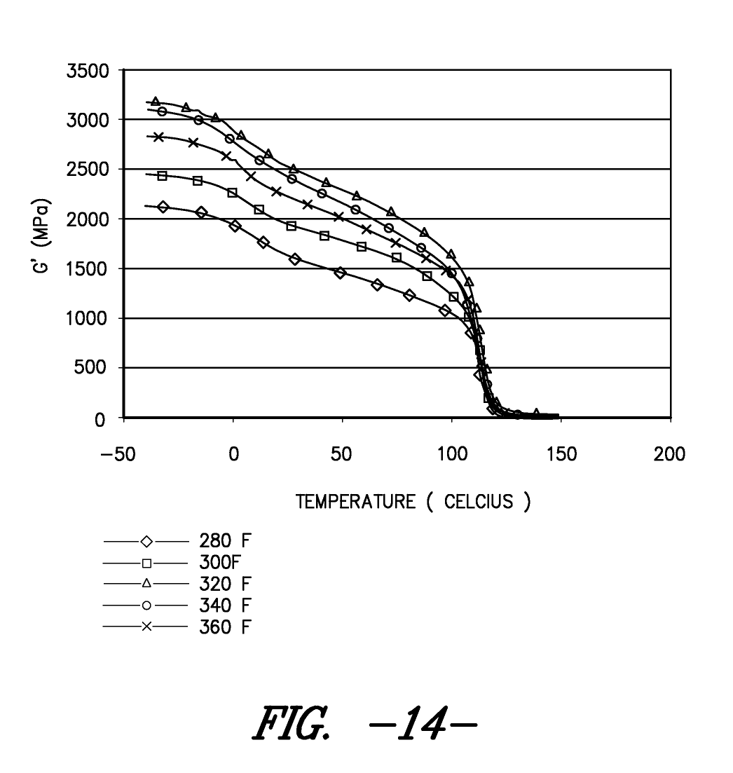

In Examples 1-5, the only difference between the samples was the consolidation temperature (with the pressure and resonance time constant). The consolidation temperature is one processing condition that determines the degree of bonding between the nanofibers. The bonding of the nanofibers is reflected by the modulus of the second intermediate e.g. the nano-composite. Dynamic Mechanical Analysis (DMA) is one way of assessing the degree of consolidation without the need for etching away the second polymer. DMA was performed on the nano-composite films of Example 1-5. The temperature sweep of the storage moduli was measured at 1 Hz and plotted in FIG. 14.

When the discontinuous phase (first polymer) is in nanofiber form, the higher the degree of bonding between the fibers the higher the modulus the second intermediate will be. When the nanofibers ripen into droplets form, the modulus will decrease due to the breakdown of the nanofiber network. In FIG. 14, the storage modulus (G′) of the second intermediates increases as the consolidation temperature increases from 280° F. to 320° F. indicating the degree of bonding between nanofibers increases while maintaining their diameter and aspect ratio. However, G′ decreases as the consolidation temperature increases from 320° F. to 360° F. indicating ripened minor phase structure that causes disintegration upon etching.

For the polymer system described in Examples 1-5 (PS 500/PP 6301), 320° F. may be considered the highest consolidation temperature for a pressure of 30 tons and a resonance time of 15 minutes. This consolidation temperature window varies depending on the materials used, consolidation pressure, and resonance time.

### Example 6

Example 6 was carried out with the same materials of Example 1, except that the weight ratio of second polymer/first polymer (PS/HPP) was 75/25. The first intermediate pellets were cryoground into powder form. A layer of the powder was used as the pre-consolidation formation. The consolidation condition and etching procedure were the same as those described in Example 1. From the SEM image shown in FIG. 15 (which was imaged after dissolution of the second polymer), it may be seen that cryogrinding the first intermediate did not damage the nanofiber structure. The nanofiber morphology maintained during the process. 70% of the nanofibers had a diameter less than 400 nm and an aspect ratio higher than 50:1.

### Example 7

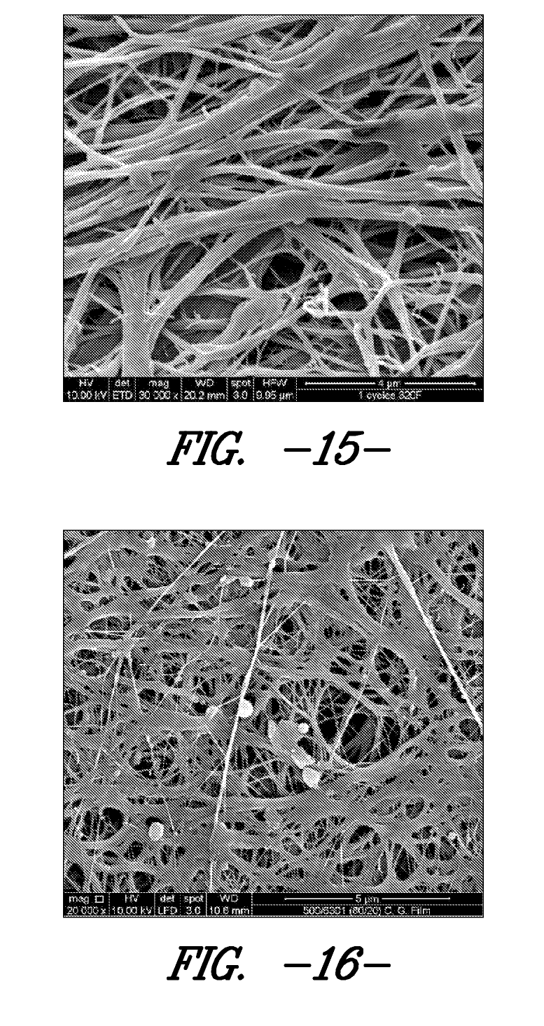

Example 7 was carried out with the same materials of Example 6. The first intermediate pellets were melt extruded into thin films (10-50 um thick) through extrusion within a Killion 32:1 KLB-100 Tilt-N-Whirl Model outfitted with a film extrusion die-head with a die temperature setting of 450° F., a melt temperature of about 425° F., and an extrusion screw rate of about 67 rpm, and collected on a roll package. At least 90% of the HPP nanofibers in the film were oriented along the machine direction (extrusion direction). When the first intermediate was etched in toluene, the film disintegrated. This indicated that only a small percentage of the nanofibers were bonded to other nanofibers so the resultant etched film had no structural integrity and contained mostly oriented individual nanofibers. The nano-composite film (not etched) was chopped into small pieces and cryoground into powder form. A layer of the powder was used as the pre-consolidation formation. The consolidation condition and etching procedure were the same as those described in Example 1. The film did not disintegrate during etching indicating that a majority of the nanofibers were bonded to other nanofibers. From the SEM image shown in FIG. 16, it may be seen that by cryogrinding and consolidation the majority of the nanofibers were randomized and fused together.

### Example 8

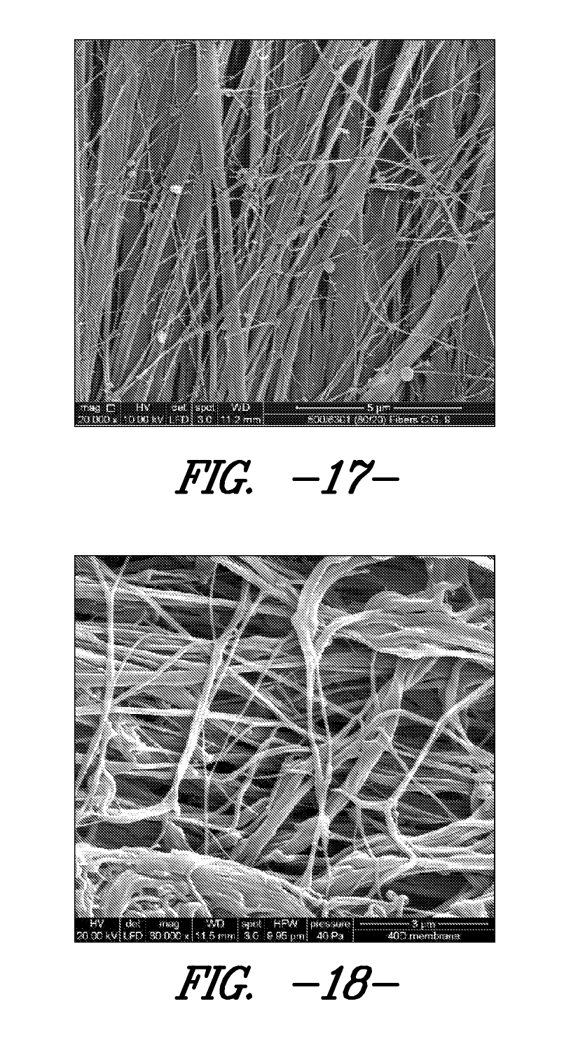

Example 8 was carried out with the same materials of Example 7. The first intermediate pellets were melt extruded into an 11 denier nano-composite fiber. The extensional force exerted on the melt created nano-fibrous HPP with an average aspect ratio of at least 1000:1. At least 90% of the HPP nanofibers in the fibers were oriented along the machine direction (extrusion direction). The fibers were then chopped into small pieces and cryoground in to powder form. A layer of powder (pre-consolidation formation) was compression molded under the same conditions as Example 1. The resulting second intermediate, the nano-composite film, was etched in the same way as Example 1. A nano-porous non-woven was formed, see FIG. 17.

### Example 9

Second polymer Total Crystal Polystyrene 535 (Total PS 535) (4 MFI, 200C, ASTM D1238) and first polymer Homopolypropylene Profax PH350 purchased from Lyondellbasell (3.5 MFI at 230C, ASTMD1238) were mixed at weight ratio of 80/20 and melt extruded into pellets as described in Example 1. The first intermediate pellets were melt extruded into an 11 denier nano-composite fiber. The extensional force exerted on the melt created nanofibers of HPP with an average aspect ratio of at least 1000:1. At least 90% of the HPP nanofibers in the fibers were oriented along the machine direction (extrusion direction). The fibers were then chopped into 2-6 inch long staple fibers and then carded and needle punched into a non-woven mat. This nonwoven mat was compression molded at the same condition as Example 1. The resulting second intermediate was etched in the same way as Example 1. A nano-porous non-woven was formed having at least 70% of the nanofibers bonded to other nanofibers. The SEM is shown in FIG. 18.

### Example 10

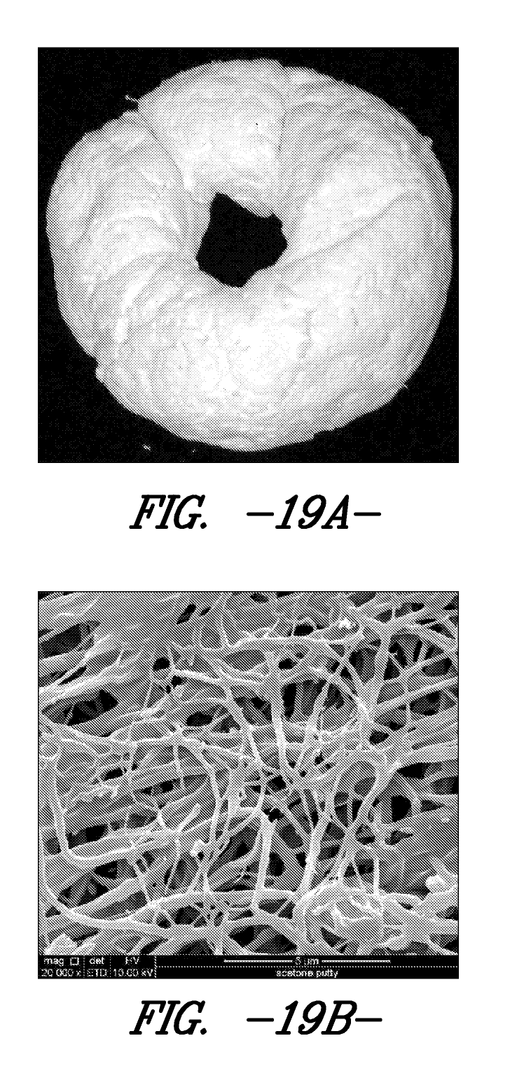

The first intermediate pellets of Example 1 were cryoground into powder form. The powders were then soaked in acetone which is a good plasticizer for PS. The powders became sticky and were able to be manipulated into a doughnut shape by hand forming the pre-consolidation formation. The “doughnut” was taken out of the solvent and heated in an oven at 320° F. for 5 minutes resulting the second intermediate. The second intermediate was immersed in toluene at room temperature for 30 minutes to remove PS from the blends. PS is soluble and PP is not soluble in toluene. This step was repeated for two more times to ensure complete removal of polystyrene. The etched article was then immersed in acetone and methanol for 30 minutes respectively then air dried. A 3D nano-porous “doughnut” was formed, see FIG. 19A. The outer diameter of the structure is ⅞ inch. The micrograph is shown in FIG. 19B. It may be seen that the nanofiber morphology of the first intermediate was retained. The nanofibers were fused to one another (while still maintaining the nanofiber structural dimensions) upon consolidation.

### Example 11

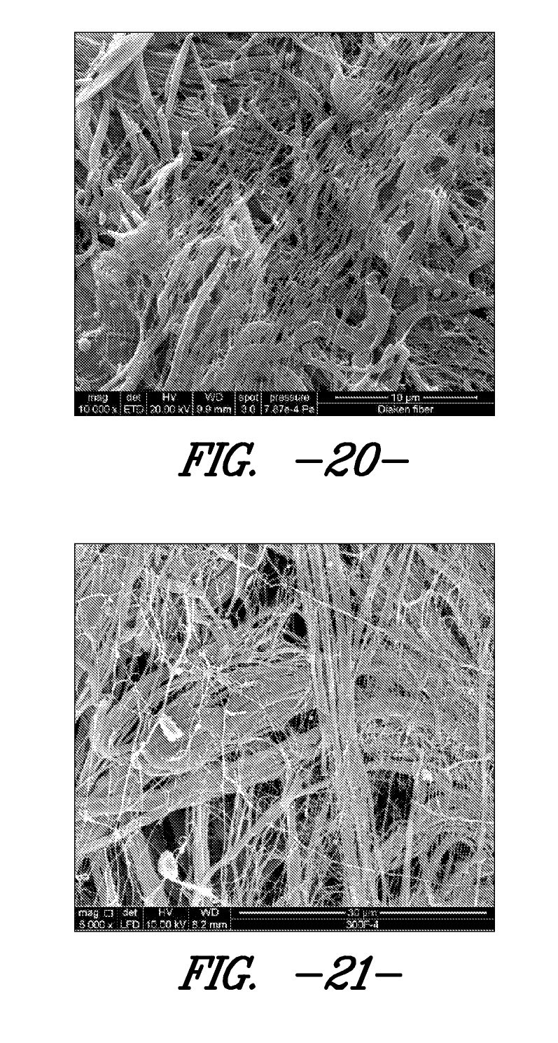

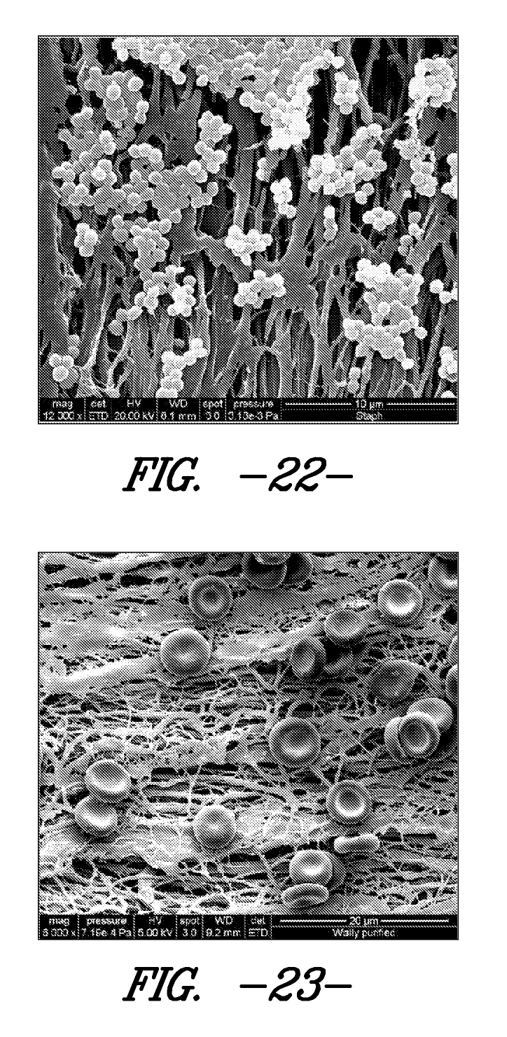

Example 11 was carried out with the same process of Example 1 with different materials. The second polymer was Total Crystal Polystyrene 535 (Total PS 535) (4 MFI, 200° C., ASTM D1238) and the first polymer was EFEP RP 4020, a fluoropolymer purchased from Daiken with a melting temperature of 320° F. (2550 MFI at 265° C. ASTM D1238). The weight ratio of the second polymer to the first polymer was 80/20. The morphology of the etched nano-composite article was observed using a SEM (FIG. 20). The nanofibers less than 800 nm in diameter were observed in the etched film. Sheet like structure were also observed. This is a result of the viscosity differences and the surface energy differences between the two polymers, the nanofibers a larger and wider distribution compared to Example 9.

### Example 12

Example 12 was carried out with the same materials as in Example 9 and the first intermediate was prepared the same way as in Example 7. The first intermediate was extruded into 12.5 um films. Two layers of film were cross lapped (meaning that the nanofiber axes of the two layers were perpendicular to each other) and consolidated at 280° F. at 30 tons for 15 minutes using a compression molder forming the second intermediate. The consolidated film was etched the same way as the other examples. Bonded nanofibers (greater than 70%) were observed in the etched nano-porous non-woven.

### Example 13

Example 13 was carried out with the same materials Example 9 and the first intermediate was prepared the same way as Example 7. The first intermediate was extruded into 12.5 um films. Two layers of film were stacked in parallel lapped (meaning that the nanofiber axes of the two layers were parallel to each other) and consolidated at 280° F. at 30 tons for 15 minutes using a compression molder forming the second intermediate. The consolidated film was etched the same way as the other examples. The film disintegrated during etching leaving parallel nanofibers behind.

### Example 14

Crystal Polystyrene Total 535 (MFI 4 g/10 min at 200C, ASTM D-1238) and homopolymer polypropylene ExxonPP3155 (MFI 36 g/10 min at 230C, ASTM D-1238) were mixed at a weigh ratio of 80:20 and processed as the same method as sample 1. The consolidation temperature was 300° F. at 1500 psi for 15 minutes. As seen in the SEM images of the etched film the fiber diameter distribution was wider compared to Examples 1 and 2 ranging from nano to micron sized, see FIG. 19. This is a result of the viscosity differences between the two polymers.

### Example 15

Example 15 was carried out with the same materials Example 9. The first intermediate was extruded into 12.5 μm films. One film was calendared on (together with) a PP commercially available non-woven at 400° F., 1500 psi using a calendar roll forming the second intermediate. The nano-composite film softened and bonded on the PP non-woven fibers. The second intermediate was then etched using toluene resulting in a two layer composite construction (a nanofiber nano-porous layer and a non-woven layer). Multiple first intermediates would be able to be stacked on the PP non-woven layer if sufficient temperature or pressure is used. The nano-porous layer contained nanofibers, of which at least 70% of the nanofibers were bonded to other nanofibers.

### Example 16

Example 16 was carried out with the same materials Example 9. The first intermediate was extruded into 12.5 μm films. One film was compression molded on a PP non-woven at 280° F., 10 ton, and 15 minutes using a hydraulic compression molder forming the second intermediate. The nano-composite film softened and bonded on the PP non-woven fibers. The second intermediate was then etched using toluene resulting in a two layer composite construction (a nanofiber nano-porous layer and a non-woven layer). Multiple first intermediates would be able to be stacked on the PP non-woven layer if sufficient temperature or pressure is used. The nano-porous layer contained nanofibers, of which at least 70% of the nanofibers were bonded to other nanofibers.

### Example 17

The nano-porous non-woven of Example 1 was used to filter industrial tap water. A majority of the rust particles were filtered. This nano-porous non-woven used as a membrane was measure to have an average pore size of 0.02 um by capillary porometry.

### Example 18

Example 1 was also used to filter Staphylococcus aureus (spherical with a diameter of 0.5-1.5 micrometers) suspension. The cells were captured on the film surface. The nano-porous non-woven with the Staphylococcus bacteria is shown in FIG. 22.

### Example 19

Example 1 was also used to filter human blood cells (typically 7-8 um in diameter). The cells were captured on the film surface, see FIG. 23. The SEM images showed Example 1 may be potentially used as a filtration membrane to filter bio cells.

### Example 20

Example 1 was also used to filter rust from tap water (the rust particles were typically less than 1 micron in diameter). The rust particles were captured on the film surface, see FIG. 24. The SEM images showed Example 1 may be potentially used as a filter for tap water.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. The process of forming a nano-composite comprising, in order:
a) mixing a first thermoplastic polymer and a second thermoplastic polymer in a molten state forming a molten polymer blend, wherein the second polymer is soluble in a first solvent, wherein the first polymer is insoluble in the first solvent, and wherein the first polymer forms discontinuous regions in the second polymer, and optionally cooling the polymer blend to a temperature below the softening temperature of the first polymer;
b) subjecting the polymer blend to extensional flow, shear stress, and heat such that the first polymer forms nanofibers having an aspect ratio of at least 5:1, and wherein less than about 30% by volume of the nanofibers are bonded to other nanofibers, wherein the nanofibers are generally aligned along an axis;
c) cooling the polymer blend with nanofibers to a temperature below the softening temperature of the first polymer to preserve the nanofiber shape forming a first intermediate;
d) forming the first intermediate into a pre-consolidation formation;
e) consolidating the pre-consolidation formation at a consolidation temperature forming a second intermediate, wherein the consolidation temperature is above the T_{g} and of both the first polymer and second polymer, wherein consolidating the pre-consolidation formation causes nanofiber movement, randomization, and at least 70% by volume of the nanofibers to fuse to other nanofibers.

2. The process of claim 1, wherein subjecting the molten polymer blend to extensional flow and shear stress comprises extruding the molten polymer blend into fibers and wherein forming the pre-consolidated formation comprises forming the fibers into a non-woven layer and stacking at least one non-woven layer.

3. The process of claim 1, wherein subjecting the molten polymer blend to extensional flow and shear stress comprises extruding the molten polymer blend into fibers and wherein forming the pre-consolidated formation comprises forming the fibers into a knit or woven layer and stacking at least one knit or woven layer and

4. The process of claim 1, wherein subjecting the molten polymer blend to extensional flow and shear stress comprises extruding the molten polymer blend into a film and wherein forming the pre-consolidated formation comprises stacking at least one of the films.

5. The process of claim 1, wherein subjecting the molten polymer blend to extensional flow and shear stress comprises extruding the molten polymer blend into pellets and wherein forming the pre-consolidated formation comprises arranging the pellets into a pellet structure.

6. The process of claim 1, wherein subjecting the molten polymer blend to extensional flow and shear stress comprises extruding the molten polymer blend into a powder and wherein forming the pre-consolidated formation comprises arranging the powder into a powder layer.

7. The process of claim 1, wherein at least 85% by volume of the nanofibers are fused to other nanofibers in the second intermediate.

8. The process of claim 1, wherein less than about 10% by volume of the nanofibers are fused to other nanofibers in the first intermediate.

9. The process of claim 1, wherein the nanofibers having an aspect ratio of at least 100:1.

10. The process of claim 1, further comprising:
f) applying the first solvent to the second intermediate dissolving away at least a portion of the second polymer.

11. The process of forming a nano-porous non-woven comprising:
a) mixing a first thermoplastic polymer and a second thermoplastic polymer in a molten state forming a molten polymer blend, wherein the second polymer is soluble in a first solvent, wherein the first polymer is insoluble in the first solvent, and wherein the first polymer forms discontinuous regions in the second polymer, and optionally cooling the polymer blend to a temperature below the softening temperature of the first polymer;
b) subjecting the polymer blend to extensional flow, shear stress, and heat such that the first polymer forms nanofibers having an aspect ratio of at least 5:1, and wherein less than about 30% by volume of the nanofibers are bonded to other nanofibers, wherein the nanofibers are generally aligned along an axis;
c) cooling the polymer blend with nanofibers to a temperature below the softening temperature of the first polymer to preserve the nanofiber shape forming a first intermediate;
d) forming the first intermediate into a pre-consolidation formation;
e) consolidating the pre-consolidation formation at a consolidation temperature forming a second intermediate, wherein the consolidation temperature is above the T_{g} and of both the first polymer and second polymer, wherein consolidating the pre-consolidation formation causes nanofiber movement, randomization, and at least 70% by volume of the nanofibers to fuse to other nanofibers;
f) applying the first solvent to the second intermediate dissolving away at least a portion of the second polymer.

12. The process of claim 11, wherein essentially the entire second polymer is dissolved away from the second intermediate.

13. The process of claim 11, wherein the nano-composite comprises a gradient in the concentration second polymer, wherein the surface of the nano-composite has a lower concentration of second polymer than the inside of the nano-composite.

14. The process of claim 11, wherein subjecting the molten polymer blend to extensional flow and shear stress comprises extruding the molten polymer blend into fibers and wherein forming the pre-consolidated formation comprises forming the fibers into a non-woven layer and stacking at least one non-woven layer.

15. The process of claim 11, wherein subjecting the molten polymer blend to extensional flow and shear stress comprises extruding the molten polymer blend into fibers and wherein forming the pre-consolidated formation comprises forming the fibers into a knit or woven layer and stacking at least one knit or woven layer and

16. The process of claim 11, wherein subjecting the molten polymer blend to extensional flow and shear stress comprises extruding the molten polymer blend into a film and wherein forming the pre-consolidated formation comprises stacking at least one film.

17. The process of claim 11, wherein subjecting the molten polymer blend to extensional flow and shear stress comprises extruding the molten polymer blend into pellets and wherein forming the pre-consolidated formation comprises arranging the pellets into a pellet structure.

18. The process of claim 11, wherein subjecting the molten polymer blend to extensional flow and shear stress comprises extruding the molten polymer blend into a powder and wherein forming the pre-consolidated formation comprises arranging the powder into a powder layer.

19. The process of claim 11, wherein at least 85% by volume of the nanofibers are fused to other nanofibers in the second intermediate.

20. The process of claim 11, wherein less than about 10% by volume of the nanofibers are fused to other nanofibers in the first intermediate.
